(19) United States
(12) Patent Application Publication
(10) Pub. No.: US 2016/0085441 A1
(43) Pub. Date: Mar. 24, 2016

(54) Method, Apparatus, and Interactive Input System

(71) Applicant: SMART Technologies ULC, Calgary (CA)

(72) Inventor: Daniel Mitchell, Calgary (CA)

(21) Appl. No.: 14/492,994

(22) Filed: Sep. 22, 2014

(51) Int. Cl. G06F 3/0488; G06F 3/0481; G06F 3/0482; G06F 3/0484

(52) U.S. Cl. CPC G06F 3/04886; G06F 3/04842; G06F 3/04847; G06F 3/04817; G06F 3/0482

(57) ABSTRACT

A method comprises displaying a window on a graphical user interface that is presented on a display screen, the window presenting a graphical tool therein; and in response to an input gesture on the graphical user interface, changing the fidelity of the graphical tool presented in the window.

### FIELD

The subject disclosure relates generally to a method, apparatus and interactive input system.

### BACKGROUND

Interactive input systems that allow users to inject input such as for example digital ink, mouse events etc. into an application program using an active pointer (eg. a pointer that emits light, sound or other signal), a passive pointer (e.g., a finger, cylinder or other object) or other suitable input device such as for example, a mouse or trackball, are well known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 and in U.S. Patent Application Publication No. 2004/0179001, all assigned to SMART Technologies ULC of Calgary, Alberta, Canada, assignee of the subject application, the entire disclosures of which are incorporated herein by reference; touch systems comprising touch panels employing electromagnetic, capacitive, acoustic or other technologies to register pointer input; tablet and laptop personal computers (PCs); personal digital assistants (PDAs) and other handheld devices; and other similar devices.

In many environments, a graphical user interface, such as a computer desktop, is presented on the touch panel allowing users to interact with displayed graphical tools and icons. For example, it is known to display a graphical tool in the form of an on-screen keyboard on a graphical user interface that allows a user to inject alphanumeric input into an executing application program by contacting keys of the on-screen keyboard. An example of such an on-screen keyboard is shown and described in U.S. Pat. Nos. 6,741,267 and 7,151,533 to Van Ieperen, assigned to SMART Technologies ULC. As will be appreciated, depending on the physical layout of the touch panel and the application programs being executed, different display formats for the displayed graphical tools may be desired.

It is an object to provide a novel method, apparatus and interactive input system.

### SUMMARY

Accordingly, in one aspect there is provided a method comprising displaying a window on a graphical user interface that is presented on a display screen, said window presenting a graphical tool therein; and in response to an input gesture on said graphical user interface, changing the fidelity of the graphical tool presented in the window.

In embodiments, the changing comprises one of changing the fidelity of the graphical tool presented in the window from a lesser fidelity to a greater fidelity and changing the fidelity of the graphical tool presented in the window from a greater fidelity to a lesser fidelity. The changing may also further comprise changing the size of the window. The graphical tool, when presented in the window in the lesser fidelity, comprises fewer selectable icons than when presented in the window in the greater fidelity. The graphical tool may take the form of an on-screen keyboard for example, with the on-screen keyboard comprising fewer selectable keys when presented in the window in the lesser fidelity than when presented in the window in the greater fidelity. The graphical tool may take the form of a tool palette for example, with the tool palette comprising fewer selectable icons when presented in the window in the lesser fidelity than when presented in the window in the greater fidelity.

In embodiments, changing the fidelity of the graphical tool presented in the window from the lesser fidelity to the greater fidelity is performed in response to a pinch-to-zoom or zoom-out gesture and changing the fidelity of the graphical tool presented in the window from the greater fidelity to the lesser fidelity is performed in response to a zoom-to-pinch or zoom-in gesture.

In embodiments, the size of the window when presenting the graphical tool in the lesser fidelity and/or when presenting the graphical tool in the greater fidelity may be user selected or predetermined. In embodiments, the number and/or arrangement of selectable icons of the graphical tool when presented in the window in the lesser fidelity and/or when presented in the window in the greater fidelity may be user selected or predetermined.

According to another aspect there is provided an apparatus comprising memory; and one or more processors communicating with said memory, said one or more processors executing program instructions stored in said memory to cause said apparatus at least to: display a window on a graphical user interface that is presented on a display screen, said window presenting a graphical tool therein; and in response to an input gesture on said graphical user interface, change the fidelity of the graphical tool presented in the window.

According to another aspect there is provided a non-transitory computer readable medium embodying executable program code, said program code when executed by one or more processors, causing an apparatus to carry out a method comprising displaying a window on a graphical user interface that is presented on a display screen, said window presenting a graphical tool therein; and in response to an input gesture on said graphical user interface, changing the fidelity of the graphical tool presented in the window.

According to another aspect there is provided an interactive input system comprising a display screen having an interactive surface on which a graphical user interface is presented; and one or more processors communicating with said display screen, said one or more processors executing an application program that causes said one or more processors to: display a window on the graphical user interface, said window presenting a graphical tool therein; and in response to an input gesture on said graphical user interface, change the fidelity of the graphical tool presented in the window.

### BRIEF DESCRIPTION OF THE DRAWINGS

Embodiments will now be described more fully with reference to the accompanying drawings in which:

FIG. 1 is a perspective view of an interactive input system;

FIG. 2 is a simplified block diagram of the software architecture of a general purpose computing device forming part of the interactive input system of FIG. 1;

FIG. 3 is a front elevational view of an interactive board forming part of the interactive input system of FIG. 1 displaying a graphical user interface and a window on the graphical user interface in which a low fidelity representation of an on-screen keyboard is presented;

FIG. 4 is a front elevational view of the interactive board of FIG. 3 showing an input pinch-to-zoom gesture on the window;

FIG. 5 is a front elevational view of the interactive board of FIG. 3 displaying the graphical user interface and the window, the window presenting a high fidelity representation of the on-screen keyboard;

FIG. 6 is a front elevational view of the interactive board of FIG. 5 showing an input zoom-to-pinch gesture on the window;

FIG. 7 is a front elevational view of the interactive board of FIG. 3 displaying the graphical user interface and the window, the window presenting a higher fidelity representation of the on-screen keyboard; and

FIGS. 8 to 10 are front elevational views of the interactive board of FIG. 3 displaying a graphical user interface and a window, the window presenting low, high and higher fidelity representations, respectively, of a tool palette.

### DETAILED DESCRIPTION OF THE EMBODIMENTS

In the following, a method, apparatus, non-transitory computer-readable medium and interactive input system are described wherein the method comprises displaying a window on a graphical user interface that is presented on a display screen, the window presenting a graphical tool therein and in response to an input gesture on the graphical user interface, changing the fidelity of the graphical tool presented in the window. By allowing the fidelity of the presented graphical tool to be changed via an input gesture, the graphical tool can be sized to minimize display screen real estate during normal or default operation while remaining functional but can be easily and readily expanded or enlarged when more sophisticated operations are desired or required.

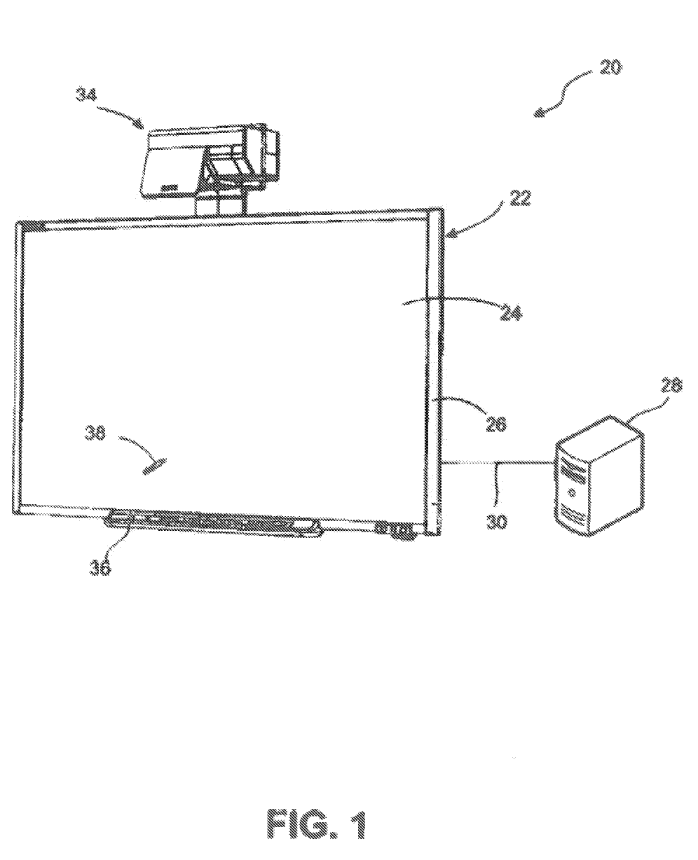

Turning now to FIG. 1, an interactive input system is shown and is generally identified by reference numeral 20. Interactive input system 20 allows one or more users to inject input such as digital ink, mouse events, commands, etc. into an executing application program. In this embodiment, interactive input system 20 comprises a digitizer or touch panel in the form of an interactive board 22 mounted on a vertical support surface such as for example, a wall surface or the like. Interactive board 22 in this embodiment is an M600 Series SMART Board®, sold by SMART Technologies ULC and comprises a generally planar, rectangular interactive surface 24 that is surrounded about its periphery by a bezel 26. An ultra-short-throw projector 34, such as that sold by SMART Technologies ULC under the name “SMART UX80”, is also mounted on the support surface above the interactive board 22 and projects a computer-generated image, such as for example, a graphical user interface in the form of a computer desktop, onto the interactive surface 24.

The interactive board 22 employs machine vision to detect one or more pointers brought into a region of interest in proximity with the interactive surface 24. The interactive board 22 communicates with a general purpose computing device 28 executing application programs via a universal serial bus (USB) cable 30 or other suitable wired or wireless communication link. General purpose computing device 28 processes the output of the interactive board 22 and adjusts image data that is output to the projector 34, if required, so that the image presented on the interactive surface 24 reflects pointer activity. In this manner, the interactive board 22, general purpose computing device 28 and projector 34 allow pointer activity proximate to the interactive surface 24 to be recorded as writing or drawing or used to control execution of application programs executed by the general purpose computing device 28.

The bezel 26 is mechanically fastened to the interactive surface 24 and comprises four bezel segments that extend along the edges of the interactive surface 24. In this embodiment, the inwardly facing surface of each bezel segment comprises a single, longitudinally extending strip or band of retro-reflective material. To take best advantage of the properties of the retro-reflective material, the bezel segments are oriented so that their inwardly facing surfaces lie in a plane generally normal to the plane of the interactive surface 24.

A tool tray 36 is affixed to the interactive board 22 adjacent the bottom bezel segment using suitable fasteners such as for example, screws, clips, adhesive etc. As can be seen, the tool tray 36 comprises a housing having an upper surface configured to define a plurality of receptacles or slots. The receptacles are sized to receive one or more pen tools 38 as well as an eraser tool that can be used to interact with the interactive surface 24. Control buttons are also provided on the upper surface of the tool tray housing to enable a user to control operation of the interactive input system 20. Further specifies of the tool tray 36 are described in International PCT Application Publication No. WO 2011/085486 filed on Jan. 13, 2011, and entitled “INTERACTIVE INPUT SYSTEM AND TOOL TRAY THEREFOR”.

Imaging assemblies (not shown) are accommodated by the bezel 26, with each imaging assembly being positioned adjacent a different corner of the bezel. Each of the imaging assemblies comprises an image sensor and associated lens assembly that provides the image sensor with a field of view sufficiently large as to encompass the entire interactive surface 24. A digital signal processor (DSP) or other suitable processing device sends clock signals to the image sensor causing the image sensor to capture image frames at the desired frame rate. During image frame capture, the DSP also causes an infrared (IR) light source to illuminate and flood the region of interest over the interactive surface 24 with IR illumination. Thus, when no pointer exists within the field of view of the image sensor, the image sensor sees the illumination reflected by the retro-reflective bands on the bezel segments and captures image frames comprising a continuous bright band. When a pointer exists within the field of view of the image sensor, the pointer occludes IR illumination and appears as a dark region interrupting the bright band in captured image frames.

The imaging assemblies are oriented so that their fields of view overlap and look generally across the entire interactive surface 24. In this manner, any pointer such as for example a user's finger, a cylinder or other suitable object, a pen tool 38 or an eraser tool lifted from a receptacle of the tool tray 36, that is brought into proximity of the interactive surface 24 appears in the fields of view of the imaging assemblies and thus, is captured in image frames acquired by multiple imaging assemblies. When the imaging assemblies acquire image frames in which a pointer exists, the imaging assemblies convey pointer data to the general purpose computing device 28, which processes the pointer data received from the imaging assemblies to compute the locations and movement of pointers proximate the interactive surface 24 using well known triangulation.

The general purpose computing device 28 in this embodiment is a personal computer or other suitable processing device comprising, for example, a processing unit comprising one or more processors, system memory (volatile and/or non-volatile memory), other non-removable or removable memory (e.g., a hard disk drive, RAM, ROM, EEPROM, CD-ROM, DVD, flash memory, etc.) and a system bus coupling the various computing device components to the processing unit. The general purpose computing device 28 may also comprise networking capabilities using Ethernet, WiFi, and/or other suitable network format, to enable connection to shared or remote drives, one or more networked computers, or other networked devices. The general purpose computing device 28 may optionally comprise one or more other input devices such as a mouse, keyboard, trackball etc.

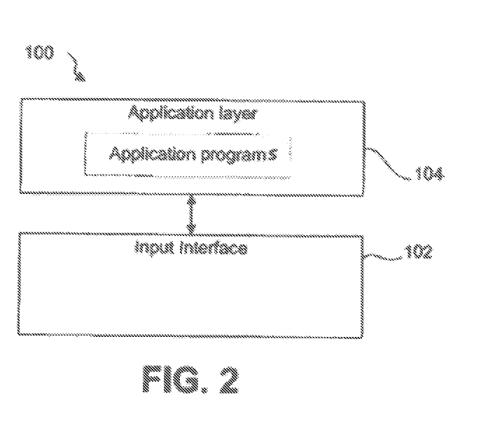

FIG. 2 shows an exemplary software architecture used by the general purpose computing device 28, and which is generally identified by reference numeral 100. The software architecture 100 comprises an input interface 102, and an application layer comprising application programs 104. The input interface 102 is configured to receive input from the interactive board 22 and the one or more other input devices of the general purpose computing device 28, if employed.

In this embodiment, the application programs 104 at least comprise one or more application programs into which alphanumeric or other keyboard input is to be injected. Application programs of this nature include but are not limited to word processing programs such as Microsoft Word™, WordPerfect™ etc., spreadsheet programs such as Microsoft Excel™, simple text editor applications etc. The application programs 104 also at least comprise an on-screen keyboard application that allows users to inject alphanumeric or other keyboard input into a running application program via user interaction with selectable icons in the form of keys of an on-screen keyboard displayed within a window that is presented on the interactive surface 24. The on-screen keyboard application can be invoked by selecting (i.e. double-clicking on) an icon displayed on the interactive surface 24 that represents the on-screen keyboard application, inputting a designated hot-key sequence via the keyboard of the general purpose computing device 28, contacting the interactive surface 24 within a text field or other similar field of the running application program or inputting a designated gesture on the interactive surface 24. In this embodiment, once invoked, the on-screen keyboard application can be toggled between low and high fidelity modes in response to input gestures as will now be described.

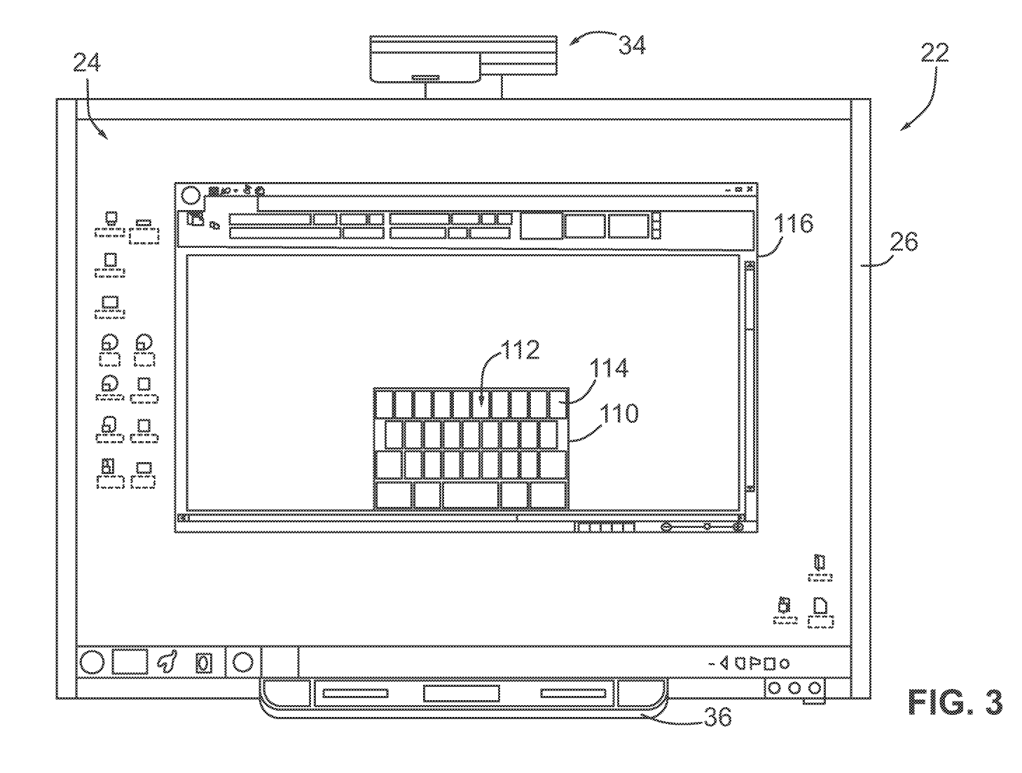

When the on-screen keyboard application is invoked, the general purpose computing device 28 updates the computer-generated image projected by the projector 34 so that a fixed or floating window 110, in which the on-screen keyboard 112 comprising a plurality of user selectable icons 114 in the form of keys is presented, is displayed on the interactive surface 24 as shown in FIG. 3. In this embodiment, at start up, the on-screen keyboard application is conditioned to the low fidelity mode. In the low fidelity mode, the window 110 is set to a default size and a low fidelity representation of the on-screen keyboard 112 is presented in the window. In this example, the low fidelity representation of the on-screen keyboard 112 comprises a subset of the keys of a typical QWERTY keyboard.

With the on-screen keyboard 112 presented in the window 110, when the user interacts with selectable keys 114 of the on-screen keyboard, corresponding keyboard input is injected into the running application program 116 associated with the on-screen keyboard application in the well known manner.

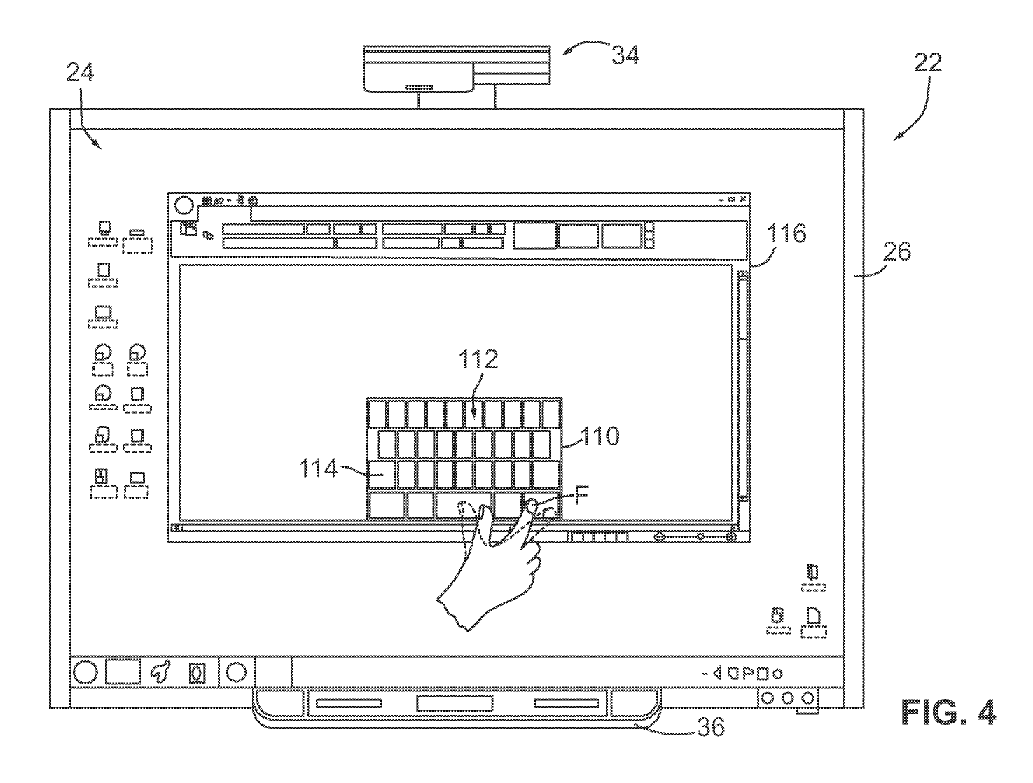

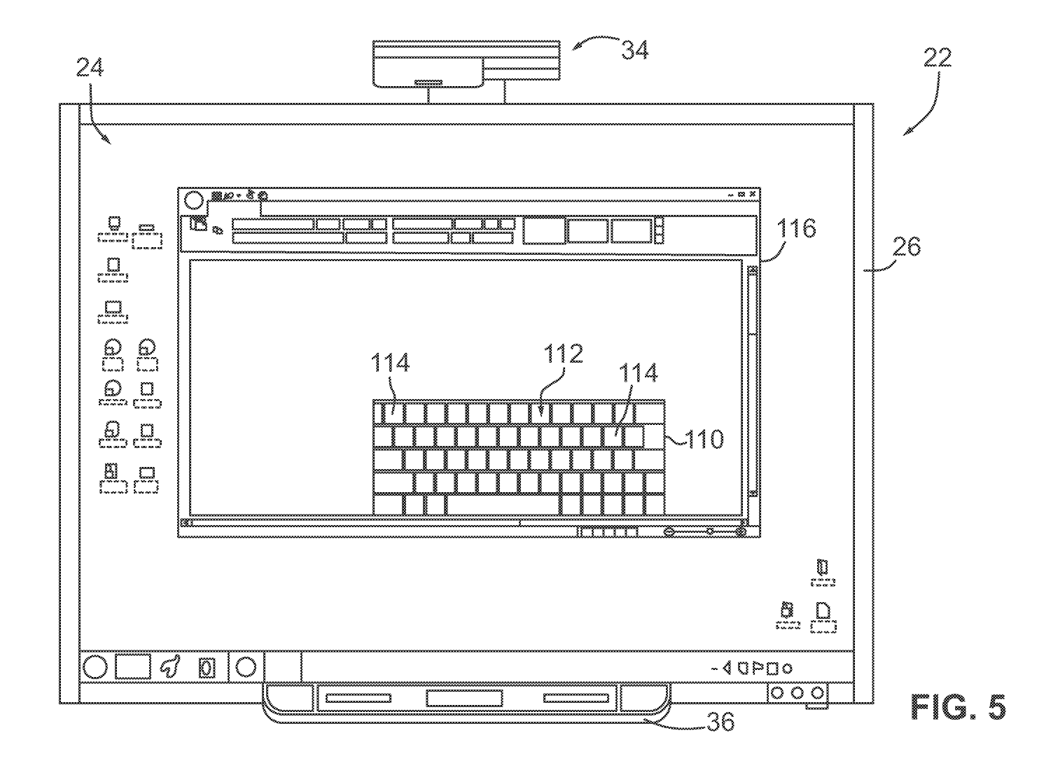

When a user performs a pinch-to-zoom or zoom-out gesture on the displayed window 110 by contacting the window with a pair of closely spaced fingers F substantially simultaneously and expanding the distance between the fingers as shown in FIG. 4 and the gesture is recognized by the general purpose computing device 28, an expand or zoom-out command is generated and processed by the on-screen keyboard application. In response, the on-screen keyboard application enters the high fidelity mode. In the high fidelity mode, the displayed window 110 is increased in size and a high fidelity representation of the on-screen keyboard 112 is presented therein as shown in FIG. 5. As can be seen, the high fidelity representation of the on-screen keyboard 112 comprises a larger number of selectable keys 114.

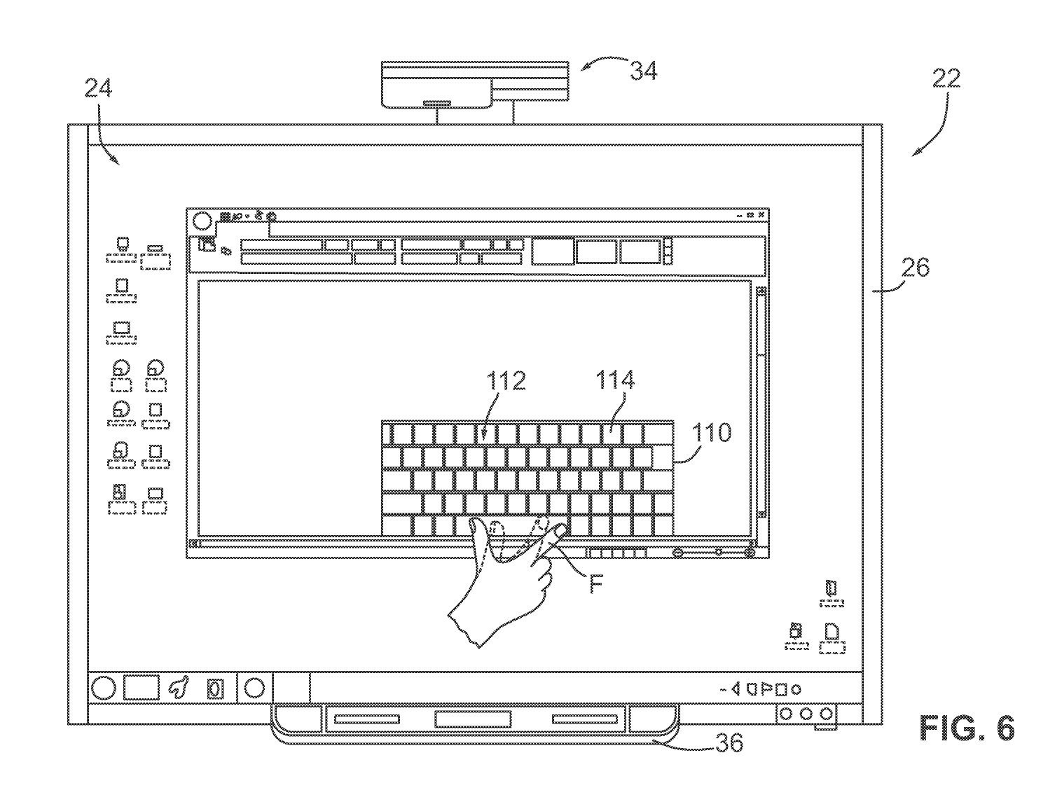

When the on-screen keyboard application is in the high fidelity mode and the user performs a zoom-to-pinch or zoom-in gesture on the displayed window 110 by contacting the window with a pair of spaced fingers F substantially simultaneously and moving the fingers in a direction towards one another as shown in FIG. 6 and the gesture is recognized by the general purpose computing device 28, a shrink or zoom-in command is generated and processed by the on-screen keyboard application. In response, the on-screen keyboard application returns to the low fidelity mode. As a result, the displayed window 110 is returned to its default size and the low fidelity representation of the on-screen keyboard 112 is presented therein as shown in FIG. 3. As will be appreciated, regardless of the fidelity mode of the on-screen keyboard application, the selectable keys 114 of the displayed on-screen keyboard 112 remain functional allowing the user to inject input into the running application program 116.

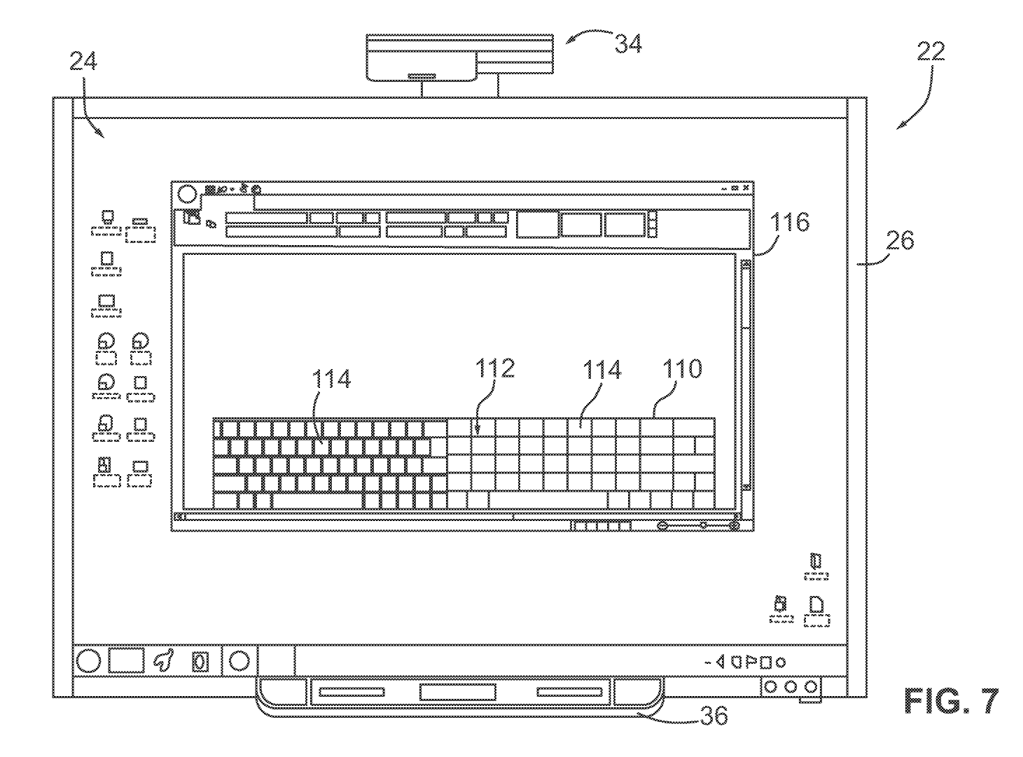

Although the on-screen keyboard application is described above as toggling between low and high fidelity modes in response to input gestures, alternatives are available. The on-screen keyboard application may in fact toggle between three or more modes in response to input gestures. For example, when the on-screen keyboard application is in the high fidelity mode, the on-screen keyboard application may enter a higher fidelity mode in response to an input gesture. In this example, when a user performs a pinch-to-zoom or zoom-out gesture on the displayed window 110 shown in FIG. 5 that is recognized by the general purpose computing device 28, an expand or zoom-out command is generated and processed by the on-screen keyboard application. In response, the on-screen keyboard application enters a higher fidelity mode. In the higher fidelity mode, the displayed window 110 is further increased in size and a higher fidelity representation of the on-screen keyboard 112 is presented therein as shown in FIG. 7. As can been seen, the higher fidelity representation of the on-screen keyboard 112 comprises an even larger number of selectable keys 114.

When the on-screen keyboard application is in the higher fidelity mode and the user performs a zoom-to-pinch or zoom-in gesture on the displayed window 110 that is recognized by the general purpose computing device 28, a shrink or zoom-in command is generated and processed by the on-screen keyboard application. In response, the on-screen keyboard application returns to the high fidelity mode. As a result, the displayed window 110 is returned to its high fidelity size and the high fidelity representation of the on-screen keyboard 112 is presented therein as shown in FIG. 5.

Those of skill in the art will appreciate that the manner by which the on-screen keyboard application switches between lesser and greater fidelity modes in response to input zoom-out and/or zoom-in gestures may vary. For example, in response to zoom-out and/or zoom-in gestures, the displayed window and on-screen keyboard may “snap” between fidelity modes. That is, in response to an expand or zoom-out command generated in response to a recognized zoom-out gesture, the size of the displayed window 110 may automatically snap from a smaller size to a larger size and the on-screen keyboard 112 may automatically snap from a lesser fidelity representation to a greater fidelity representation and in response to a shrink or zoom-in command generated in response to a recognized zoom-in gesture, the size of the displayed window 110 may automatically snap from a larger size to a smaller size and the on-screen keyboard 112 may automatically snap from a greater fidelity representation to a lesser fidelity representation.

Alternatively, when a zoom-out gesture is performed on the displayed window 110 and the on-screen keyboard application is conditionable to a greater fidelity mode, the displayed window 110 and on-screen keyboard 112 initially may gradually increase in size in response to the generated expand or zoom-out command. When the displayed window 110 and on-screen keyboard 112 reach a threshold size, the displayed window may then automatically snap from its current size to a larger size and on-screen keyboard may then automatically snap from a lesser fidelity representation to a greater fidelity representation. Similarly, when a zoom-in gesture is performed on the displayed window 110 and the on-screen keyboard application is conditionable to a lesser fidelity mode, the displayed window 110 and on-screen keyboard application 112 initially may gradually decrease in size in response to the generated shrink or zoom-in command. When the displayed window 110 and on-screen keyboard 112 reach a threshold size, the displayed window may then automatically snap from its current size to a smaller size and on-screen keyboard may then automatically snap from a greater fidelity representation to a lesser fidelity representation. If desired, when the displayed window 110 and on-screen keyboard reach one of the threshold sizes, the displayed window and on-screen keyboard need not automatically snap to a different size and another fidelity representation. Instead, the displayed window may only further change size and on-screen keyboard may only switch to another fidelity representation when the input gesture is further performed. Of course, other fidelity mode switching techniques may be employed.

If desired, the on-screen keyboard application may be inhibited from switching from a lesser fidelity mode to a greater fidelity mode if the size of the window in which the running application program 116 is presented is below a threshold size. Alternatively, the size of the window in which the running application program 116 is presented may be automatically increased to accommodate the switch of the on-screen keyboard application from a lesser fidelity mode to a greater fidelity mode.

As will be appreciated, although the on-screen keyboard application is described as a standalone application that can be invoked by selecting (i.e. double-clicking on) an icon displayed on the interactive surface 24 that represents the on-screen keyboard application, inputting a designated hot-key sequence via the keyboard of the general purpose computing device 28, contacting the interactive surface 24 within a text field or other similar field of the running application program or inputting a designated gesture on the interactive surface 24, alternatives are available. For example, the on-screen keyboard application may form part of another application and may be dynamically or statically linked into the application.

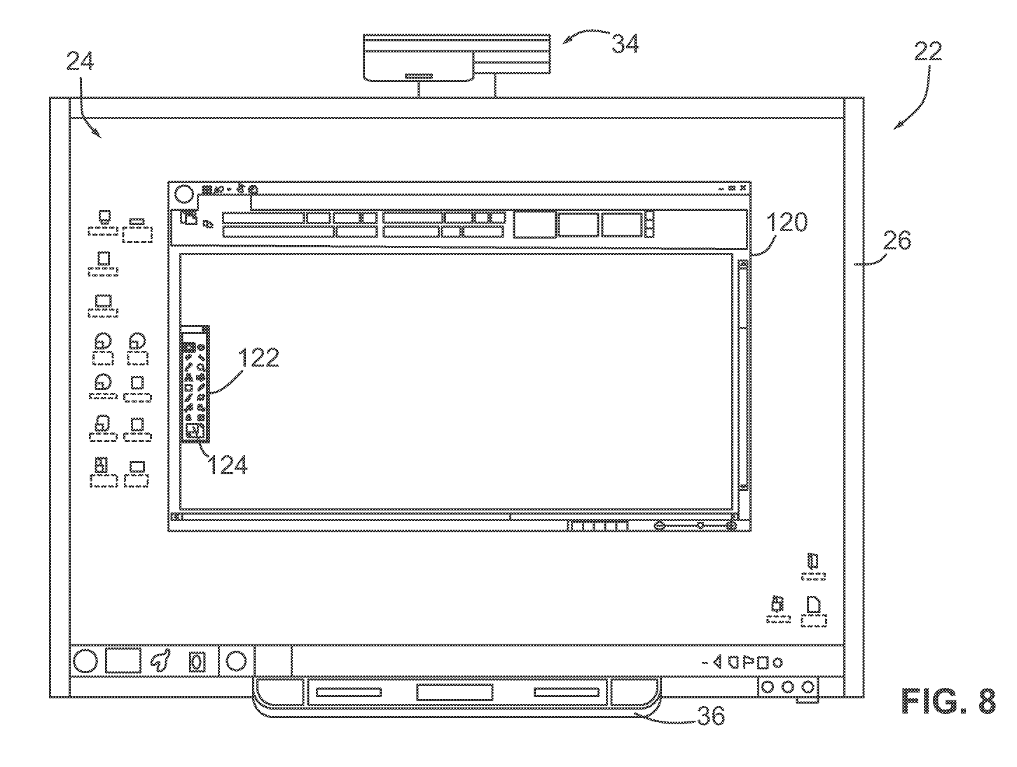

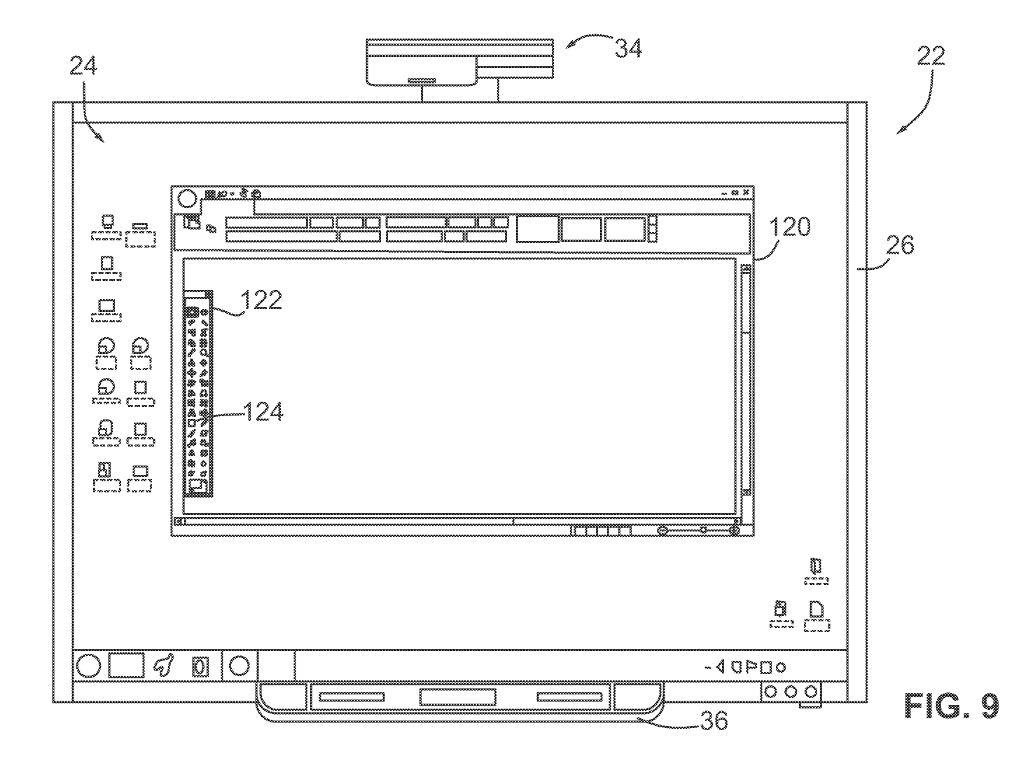

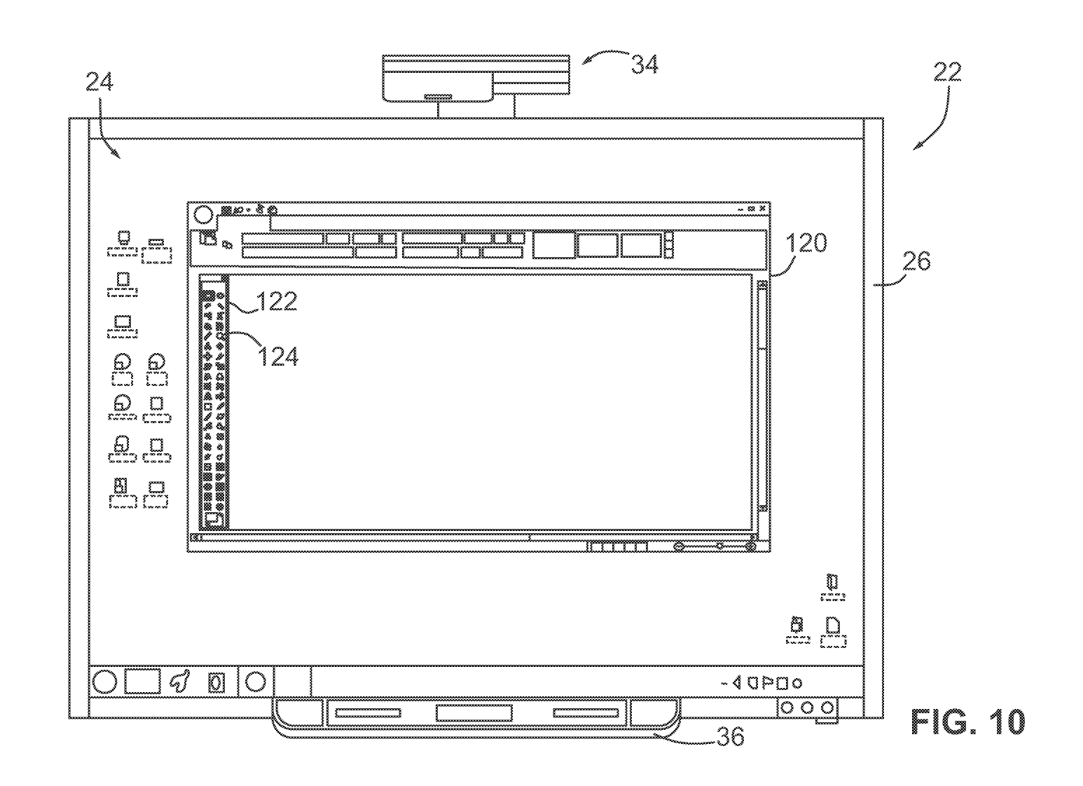

Those of skill in the art will appreciate that the fidelity changing methodology described above can be employed in application programs other than on-screen keyboard applications. For example, the fidelity changing methodology may be employed in application programs that display windows in which tool palettes comprising selectable icons are presented. FIGS. 8 to 10 show a window 120 of an image editing application (e.g. GIMP—GNU Image Manipulation Program or Photoshop) that comprises a window 122 in which a tool palette is presented in low, high and higher fidelity modes. In the low fidelity mode, the tool palette window 122 is the smallest and as result, the tool palette comprises the fewest number of selectable icons 124. In the high fidelity mode, the tool palette window 122 is larger and as a result, the tool palette comprises a larger number of selectable icons 124. In the higher fidelity mode, the tool palette window 122 is even larger and as a result, the tool palette comprises an even larger number of selectable icons 124. Similar to the previous embodiment, when a user performs a pinch-to-zoom or zoom-out gesture on the displayed tool palette window 122, which is recognized by the general purpose computing device 28, and the displayed tool palette is in the low or high fidelity mode, an expand or zoom-out command is generated and processed by the image editing application resulting in the tool palette changing to the high or higher fidelity mode. When the user performs a zoom-to-pinch or zoom-in gesture on the displayed tool palette window 122, which is recognized by the general purpose computing device 28, and the displayed tool palette is in the higher or high fidelity mode, a shrink or zoom-in command is generated and processed by the image editing application resulting in the tool palette changing to the high or low fidelity mode. As will be appreciated, the tool palette may form part of the image editing application 120 itself and may be dynamically or statically linked into the application. Alternatively, in other embodiments, the tool palette may be executed as a standalone application program that is invoked by the image editing application 120.

If desired, each application program employing the fidelity changing methodology may be customizable by the user. In this case, the application program may be conditioned to start up in a fidelity mode other than the low fidelity mode. The sizes of the windows in one or more of the fidelity modes and/or the thresholds may be user configurable. In certain instances, the number and/or arrangement of selectable icons that are presented in the window in one or more of the fidelity modes may be user selected. Those of skill in the art will also appreciate that alternative zoom-out and/or zoom-in gestures may be employed to condition the application program to different fidelity modes. In some embodiments, lesser fidelity modes of an application may include keys or selectable icons that are not available in greater fidelity modes. Conversely, in some embodiments, greater fidelity modes of an application may include keys or selectable icons and associated functions that are not available in the lesser fidelity modes. That is, keys or icons of lesser fidelity modes need not be a subset of the keys or icons of greater fidelity modes.

The application programs may comprise program modules including routines, instruction sets, object components, data structures, and the like, and may be embodied as executable program code stored on a non-transitory computer readable medium. The computer readable medium is any data storage device that can store data. Examples of non-transitory computer readable media include but are not limited to, for example, read-only memory, random-access memory, CD-ROMs, magnetic tape, USB keys, flash drives and optical data storage devices. The executable program code can also be distributed over a network including coupled computer systems so that the computer readable program code is stored and executed in a distributed fashion.

Although in embodiments described above, the digitizer or touch panel is described as comprising machine vision to register pointer input, those skilled in the art will appreciate that digitizers or touch panels employing other machine vision configurations, analog resistive, electromagnetic, capacitive, acoustic or other technologies to register input may be employed. The digitizer or touch panel need not be mounted on a wall surface. The digitizer or touch panel may be suspended or otherwise supported in an upright orientation or may be arranged to take on an angled or horizontal orientation.

In embodiments described above, a projector is employed to project the computer-generated image onto the interactive surface 24. Those of skill in the art will appreciate that alternatives are available. For example, the digitizer or touch panel may comprise a display panel such as for example a liquid crystal display (LCD) panel, a plasma display panel etc. on which the computer-generated image is presented.

Those of skill in the art will also appreciate that the graphical tool fidelity changing methodology may be employed in other computing environments in which graphical tools are displayed on a graphical user interface and where it is desired to change the fidelity of the graphical tool representations. For example, the graphical tool fidelity changing methodology may be employed on smartphones, personal digital assistants (PDA) and other handheld devices, laptop, tablet and personal computers and other computing devices.

Although embodiments have been described above with reference to the accompanying drawings, those of skill in the art will appreciate that variations and modifications may be made without departing from the scope thereof as defined by the appended claims.

What is claimed is:

1. A method comprising:
displaying a window on a graphical user interface that is presented on a display screen, said window presenting a graphical tool therein; and
in response to an input gesture on said graphical user interface, changing the fidelity of the graphical tool presented in the window.

2. The method of claim 1 wherein said changing comprises one of changing the fidelity of the graphical tool presented in the window from a lesser fidelity to a greater fidelity and changing the fidelity of the graphical tool presented in the window from a greater fidelity to a lesser fidelity.

3. The method of claim 2 wherein said changing further comprises changing the size of the window.

4. The method of claim 3 wherein the graphical tool, when presented in the window in the lesser fidelity, comprises fewer selectable icons than when presented in the window in the greater fidelity.

5. The method of claim 2 wherein the graphical tool, when presented in the window in the lesser fidelity, comprises fewer selectable icons than when presented in the window in the greater fidelity.

6. The method of claim 5 wherein the graphical tool is one of an on-screen keyboard and a tool palette.

7. The method of claim 4 wherein the graphical tool is one of an on-screen keyboard and a tool palette.

8. The method of claim 3 wherein changing the fidelity of the graphical tool presented in the window from the lesser fidelity to the greater fidelity is performed in response to a zoom-out gesture and wherein changing the fidelity of the graphical tool presented in the window from the greater fidelity to the lesser fidelity is performed in response to a zoom-in gesture.

9. The method of claim 8, wherein in response to the zoom-out gesture, changing the size of the window comprises one of (i) snapping the size of the window from a smaller size to a larger size and concurrently changing the fidelity of the graphical tool presented in the window from said lesser fidelity to said greater fidelity, (ii) gradually increasing the size of the window and the graphical tool presented therein until the window reaches a threshold size and then snapping the size of the window from its current size to a larger size and concurrently changing the fidelity of the graphical tool presented in the window from said lesser fidelity to said greater fidelity, and (iii) gradually increasing the size of the window and the graphical tool presented therein until the window reaches a threshold size and when the zoom-out gesture is further performed, increasing the size of the window from its current size to a larger size and changing the fidelity of the graphical tool presented in the window from the lesser fidelity to said greater fidelity.

10. The method of claim 9, wherein in response to the zoom-in gesture, changing the size of the window comprises one of (i) snapping the size of the window from a larger size to a smaller size and concurrently changing the fidelity of the graphical tool presented in the window from said greater fidelity to said lesser fidelity, (ii) gradually decreasing the size of the window and the graphical tool presented therein until the window reaches a threshold size and then snapping the size of the window from its current size to a smaller size and concurrently changing the fidelity of the graphical tool presented in the window from said greater fidelity to said lesser fidelity, and (iii) gradually decreasing the size of the window and the graphical tool presented therein until the window reaches a threshold size and when the zoom-in gesture is further performed, decreasing the size of the window from its current size to a smaller size and changing the fidelity of the graphical tool presented in the window from the greater fidelity to said lesser fidelity.

11. The method of claim 3 wherein the size of the window is user selectable.

12. The method of claim 4 wherein the number and/or arrangement of selectable icons when presented in the window in the lesser fidelity and/or greater fidelity is user selectable.

13. An apparatus comprising:
memory; and
one or more processors communicating with said memory, said one or more processors executing program instructions stored in said memory to cause said apparatus at least to:
display a window on a graphical user interface that is presented on a display screen, said window presenting a graphical tool therein; and
in response to an input gesture on said graphical user interface, change the fidelity of the graphical tool presented in the window.

14. The apparatus of claim 13 wherein said one or more processors cause said apparatus to one of change the fidelity of the graphical tool presented in the window from a lesser fidelity to a greater fidelity and change the fidelity of the graphical tool presented in the window from a greater fidelity to a lesser fidelity.

15. The apparatus of claim 14 wherein said one or more processors cause said apparatus also to change the size of the window.

16. The apparatus of claim 15 wherein the graphical tool, when presented in the window in the lesser fidelity, comprises fewer selectable icons than when presented in the window in the greater fidelity.

17. The apparatus of claim 14 wherein the graphical tool, when presented in the window in the lesser fidelity, comprises fewer selectable icons than when presented in the window in the greater fidelity.

18. The apparatus of claim 17 wherein the graphical tool is one of an on-screen keyboard and a tool palette.

19. The apparatus of claim 15 wherein said one or more processors cause said apparatus to change the fidelity of the graphical tool presented in the window from the lesser fidelity to the greater fidelity in response to a zoom-out gesture and to change the fidelity of the graphical tool presented in the window from the greater fidelity to the lesser fidelity in response to a zoom-in gesture.

20. The apparatus of claim 19, wherein in response to the zoom-out gesture, changing the size of the window comprises one of (i) snapping the size of the window from a smaller size to a larger size and concurrently changing the fidelity of the graphical tool presented in the window from said lesser fidelity to said greater fidelity, (ii) gradually increasing the size of the window and the graphical tool presented therein until the window reaches a threshold size and then snapping the size of the window from its current size to a larger size and concurrently changing the fidelity of the graphical tool presented in the window from said lesser fidelity to said greater fidelity, and (iii) gradually increasing the size of the window and the graphical tool presented therein until the window reaches a threshold size and when the zoom-out gesture is further performed, increasing the size of the window from its current size to a larger size and changing the fidelity of the graphical tool presented in the window from the lesser fidelity to said greater fidelity.

21. The apparatus of claim 20, wherein in response to the zoom-in gesture, changing the size of the window comprises one of (i) snapping the size of the window from a larger size to a smaller size and concurrently changing the fidelity of the graphical tool presented in the window from said greater fidelity to said lesser fidelity, (ii) gradually decreasing the size of the window and the graphical tool presented therein until the window reaches a threshold size and then snapping the size of the window from its current size to a smaller size and concurrently changing the fidelity of the graphical tool presented in the window from said greater fidelity to said lesser fidelity, and (iii) gradually decreasing the size of the window and the graphical tool presented therein until the window reaches a threshold size and when the zoom-in gesture is further performed, decreasing the size of the window from its current size to a smaller size and changing the fidelity of the graphical tool presented in the window from the greater fidelity to said lesser fidelity.

22. The method of claim 19 wherein the size of the window is user selectable.

23. The method of claim 22 wherein the number and/or arrangement of selectable icons when presented in the window in the lesser fidelity and/or greater fidelity is user selectable.

24. The apparatus of claim 13 wherein said apparatus is one of an interactive board, a digitizer or touch panel, a tablet computing device, a personal computer, a laptop computer, a smartphone, and a personal digital assistant.

25. A non-transitory computer readable medium embodying executable program code, said program code when executed by one or more processors, causing an apparatus to carry out a method comprising:
displaying a window on a graphical user interface that is presented on a display screen, said window presenting a graphical tool therein; and
in response to an input gesture on said graphical user interface, changing the fidelity of the graphical tool presented in the window.

26. An interactive input system comprising:
a display screen having an interactive surface on which a graphical user interface is presented; and
one or more processors communicating with said display screen, said one or more processors executing an application program that causes said processing structure to:
display a window on the graphical user interface, said window presenting a graphical tool therein; and
in response to an input gesture on said graphical user interface, change the fidelity of the graphical tool presented in the window.
